(19) United States
(12) Patent Application Publication
(10) Pub. No.: US 2013/0332934 A1
(43) Pub. Date: Dec. 12, 2013

(54) Task Control in a Computing System

(71) Applicants: Ernest Hood, JR., Tomball, TX (US); Jafar Alizadeh, Houston, TX (US); Keith A. Rogers, Spring, TX (US)

(72) Inventors: Ernest Hood, JR., Tomball, TX (US); Jafar Alizadeh, Houston, TX (US); Keith A. Rogers, Spring, TX (US)

(21) Appl. No.: 14/001,794

(22) PCT Filed: Mar. 8, 2011
(86) PCT No.: PCT/US11/27625

§ 371 Date: Aug. 27, 2013

(51) Int. Cl. G06F 9/44

(52) U.S. Cl. CPC G06F 9/4436
USPC 718/102

(57) ABSTRACT

A computing system can include sensor and a task. The sensor can generate sensor data. The computing system can delay the task based on the sensor data.

### BACKGROUND

Computing systems have applications that perform functions on a set schedule. For example a computer may have a virus scan or update applications that execute on a schedule. These tasks can cause other applications to execute more slowly as resources of the computing system are directed to the execution of a task if the task is scheduled to execute.

### BRIEF DESCRIPTION OF THE DRAWINGS

Some embodiments of the invention are described with respect to the following figures:

FIG. 1 is a block diagram of a computing system task controller according to an example embodiment;

FIG. 2 is a block diagram of a computing system task controller according to an example embodiment;

FIG. 3 is a flow diagram of a method of controlling a task according to an example embodiment;

FIG. 4 is a flow diagram of a method of controlling a task according to an example embodiment; and

FIG. 5 is a block diagram of a computing system according to an example embodiment.

### DETAILED DESCRIPTION

A task that executes on a schedule may cause resources to be redirected from an application that a user causing to be executed to the task that is executing on a schedule. If resources are directed away from the application that the user is causing to be executed then executing of the application may be slowed compared to executing the application without a task using resources. For example if a user is trying to access the internet through a web browser or edit a document the computing system may appear to be executing slowly if a task, such as a maintenance task, is executed when the user is executing an application. A maintenance task may be for example, virus scan, backup utility, or automatic update.

A computing system draws power and to prevent the computing system from drawing a power when the computing system is not being used a power management system can cause the computing system to enter a low power state. In a computing system that uses ACPI, a low power state can be for example, suspend, standby, hibernation, or another low power state. If a system is in a low power state and a task is scheduled to execute at a specified time the task may not be performed until the computing system is taken out of the low power state. Therefore if determining if a task should be executed is based on time then the task may have to override the power management system to perform the task or the task may redirect resources from an another application. If a task can be executed when a system is not being used but has not entered a low power state the computing system may be more efficient than if the computing system has to override the power management system to perform a task.

A computing system may be always on always connected (AOAC) such as cell phones and tablets. Always on always connected means that the data can be sent to the computing system without the computing system requesting the data, for example email pushed to a cell phone. A computing system that is always on always connected has logic to extend the battery life since the computing system is always on. An always on always connected system may have a low voltage processor to conserve battery power as compared to a desktop computing system processor. If a task is executed when the computing system is conserving battery power it can decrease the amount of time before the computing system battery has to be recharged.

A sensor may be used to determine if a task can be run without redirecting resources from an application that is being caused to be executed by a user. For example a sensor may be a proximity sensor. The sensor may determine that a user is present within a specified range of the sensor and cause a task to be delayed until the user is not present. A delay can include postponement of a task that has not begun to execute and a delay can include a suspension of a task that has already begun to execute. A task that is already executing on the computing system when a user approaches the computing system may be suspended from executing until the proximity sensor does not detect the user's presence. Delaying or suspending a task on an always on always connected computing system can also reduce the redirection of resources to the task.

The computing system may include sensors that detect other characteristics that the computing system can use to determine if the task should be executed. For example a sensor that detects the amount of ambient light may be used to determine if the task should be executed. The ambient light sensor may be in addition to the proximity sensor and the computing system may execute the task if the user is not present and the ambient light sensor detects that the room is dark for example. If there are multiple sensors they can be used individually or in combination to determine if a task should be executed or delayed based on data from the sensors.

Delaying tasks can cause a computing system to execute a task during an idle time of the computing system. A schedule that executes a task at a scheduled time and does not rely on a sensor to determine whether a task should be executed from the surroundings of the computing system can impact the user experience by directing processing power away from the application that the user is causing to be executed.

In one embodiment, a computing system can include a task scheduler a sensor and a controller. The sensor can generate data on the presence of a user. The controller can receive data from the sensor and can delay or execute a task in the task scheduler based on the sensor data.

In an another embodiment, a method of controlling tasks in a computing system can determine the presence of a user from sensor data and determine if executing a task would decrease performance of the computing system. The task can be delayed if sensor data indicates the computing system is in use and the execution of the task would decrease performance of the computing system.

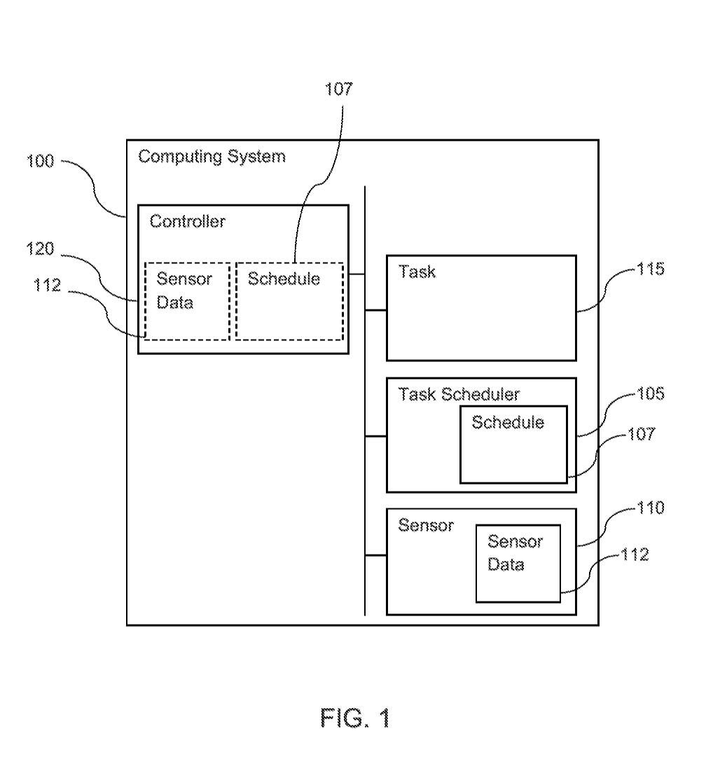

With reference to the figures, FIG. 1 is a block diagram of a computing system task controller according to an example embodiment. A computing system 100 can include a task scheduler 105 to schedule a task 115. The schedule 107 can specify a time that the task is to be executed. The specified time can be a recurring time or a single time. If the task is a recurring task the task may be executed at the same time every period, for example a week, month, year, or etc. The schedule 107 may include data about whether to execute a task 115 based on sensor data 112 from a sensor 110.

The sensor 110 can generate data on external criteria such as the computing system's surroundings, for example the sensor 110 may be a proximity sensor that can generate sensor data 112 on objects within the sensor range of the proximity sensor. Other example sensors 110 may be an ambient light sensor to determine if the area around the computing system 110 is dark or an accelerometer to determine if the system is moving.

A controller 120 can receive sensor data 112 from the sensor 110 and delay or execute a task 115 in the task scheduler 105 based on the sensor data 112. The controller 120 may be for example a general purpose microprocessor that can execute instructions from an application using its instruction set.

A task 115 can register in the task scheduler 105. For example if a new virus protection application, back up application, update application or any other application is installed on the computing system that has a task, then the task can register with the task scheduler 105. The task scheduler 105 can determine the best time to execute the task 115, receive a schedule from the task 115, or prompt the user to specify a time to execute the task. The task scheduler 105 associates the task 115 with the sensor 110. The task scheduler 105 may be part of an operating system, part of the BIOS, a separate application, or other logic.

The controller 120 can receive the schedule 107 for the task 115 and the sensor data 112. The controller 120 can determine from the schedule 107 and the sensor data 112 if it should execute the task 115. For example the schedule may include criteria used to determine whether to execute the task. The criteria may be that the task 115 is not executed if the sensor data 112 indicates that a user is within a specified distance from the sensor 110, such as the user is within a threshold such as 1 meter, 2 meters or the sensor's range of view. The sensor data 112 may also be used to determine if a user is approaching the sensor 110 or moving away from the sensor 110. If for example the user is approaching the sensor 110 the computing system 100 may delay the task and if the user is moving away from the sensor 110 the computing system 100 may execute the task 115. A schedule 107 may also cause the controller 120 to execute the task 107 when a user is within a threshold distance of the computing system 100 and delay execution of the task 115 if the user is not within a threshold distance of the computing system 100.

A task 115 that is executed if the user is within the threshold may be, for example a task 115 that is going to request user input, such as a popup box that requests that the user answer a question. A task 115 may trigger the execution of another task, for example if a task 115 requests user input it may execute if the user is in proximity to the sensor 110 and the user input causes another task to he scheduled that may be executed without user input and therefore delayed until the user is outside the threshold distance from the sensor 110. If a task 115 is to execute an update, the task 115 may have a notification that requests the user to agree to the update and then the task 115 may schedule the update task to be executed if the user is not within the threshold distance of the sensor 110, for example.

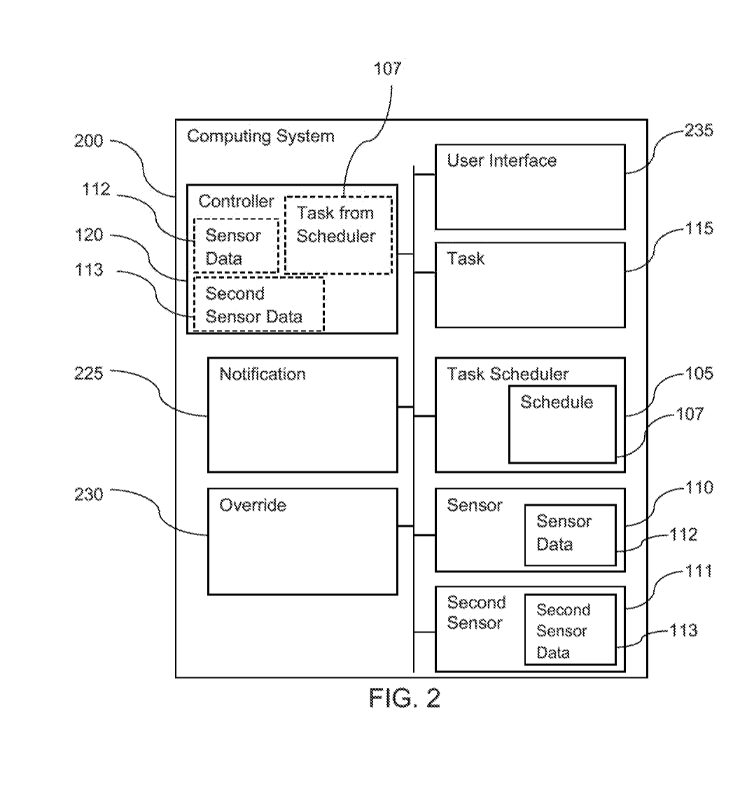

FIG. 2 is a block diagram of a computing system task controller according to an example embodiment. The computing system 200 can include a notification 225 to the user that a task 115 has been delayed from executing. The notification may be for example an audible or visual indictor such as a sound or a visual prompt on a display of the computing system 200. The notification 225 may be set in the task scheduler 105. The task scheduler 105 may associate a notification 225 with the task. The notification 225 may indicate the name of the task and provide a status of the execution of the task 115, for example. The notification 225 may indicate for example that the task is delayed and may include when the task will be executed. If the notification 225 indicates when the task will be executed then the criteria for execution from the task scheduler 105 may be displayed. The notification 225 m indicate that the task will execute when the users presence is not detected and when the area around the sensor 110 is dark.

The system may include an override 230 to allow a user to execute the task 115 if the controller 120 has delayed the task 115 based on the sensor data 112. The override 230 may be presented to the user with the notification 225 that the task is delayed. An override 230 may also be able to begin the execution of a task 115 even if a notification 225 of the delay is not indicated. The user may want to override 230 for example the delay for an update that should be installed, override 230 the criteria of the schedule 107 for a task 115 or may override 230 a portion of the criteria. For example if the schedule 107 for a task 115 indicates that the task is to be executed by the controller if the user has not been within the threshold distance for 15 minutes and the sensor has not detected ambient light for 15 minutes the override may override the criteria that a user is not present, may override 230 the criteria that the room is not dark or may override both criteria of the schedule 107. The override may be a button, icon or another input.

A user interface 235 can select whether the execution of a task is affected by the data from the sensor 110 or second data 113 from a second sensor 111. The computer system may include a plurality of sensors such as, a proximity sensor, an ambient light sensor, an accelerometer or other sensors. The controller 120 may determine whether the execution of a task is affected by the sensor data based on logical determination such as AND, OR, XOR. The user interface 235 presents the schedule 107 of a task 115 to the user. The user interface 235 may be presented on a display and allow the user to adjust the criteria of the schedule 107. The criteria can be selected to cause the execution of the task 115 to be delayed. The criteria can indicate for example whether proximity sensor data, ambient light data, accelerometer data, vibration data or any other data is considered by the controller to delay the task 115.

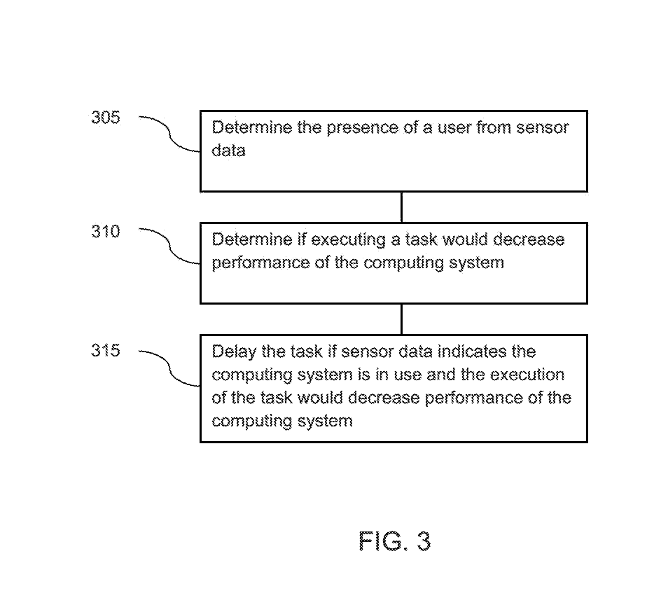

FIG. 3 is a flow diagram of a method of controlling a task according to an example embodiment. The method of controlling tasks in a computing system can determine the presence of a user from sensor data (at 305). The sensor data can be transferred to a controller that analyzes the data from the sensor. The data may be used to determine if a user is within a threshold distance from the sensor, whether the user is moving toward the sensor, whether the user is moving away from the sensor, whether the room is dark if the room is light. Whether the room is dark or light can be determined on a threshold level by measuring the luminance at the sensor.

The controller can determine if executing a task may decrease performance of the computing system (at 310). The controller may determine that by executing the task that the resources, such as processor threads or memory, may be used such that a user would be able to perceive that the computing system is responding slower than when the task is not being executed. The controller may apply a threshold to the processor threads or memory to determine if the user would perceive the computing system responding slower. The threshold applied by the controller may be dynamic based on the application that the system is trying to execute along with the task. The controller can delay the task from executing if sensor data indicates the computing system is in use and the execution of the task would decrease performance of the computing system (at 315). In use may include for example if the sensor data indicates that while the computing system is not receiving an input from the user through an input device such as a keyboard or mouse that the user has demonstrated a characteristic, such as approaching the computing system, that indicates that the user will use the computing system and the controller causes the task to be delayed.

The task that is executed by the method can be a maintenance task. A maintenance task may be one that protects data such as a virus protection, backup, update task, or another maintenance task. A maintenance task may be a task that is not interactive. For example, a maintenance task may not use user input to complete a task but may use user input for configuration prior to beginning a maintenance task.

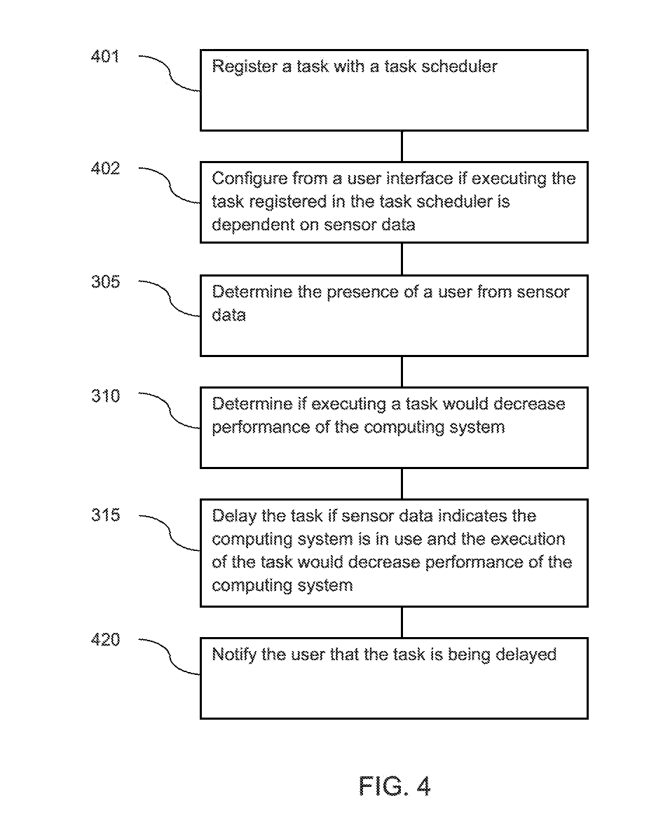

FIG. 4 is a flow diagram of a method of controlling a task according to an example embodiment. The method can begin by registering a task with a task scheduler (at 401). The task scheduler may be part of an operating system, part of the BIOS, may be a separate application, or maybe other logic. A task may register with the task scheduler through an application programming interface (API). If a task has registered with the task scheduler the task is put on a schedule that indicates criteria that will cause the task to be executed or delayed.

The task scheduler can be configured from a user interface if executing the task registered in the task scheduler is dependent on sensor data (at 402). The user interface can indicate the task that is on the schedule and also the available criteria that can be used to determine if the task is executed or delayed. The criteria can be for example a list of the sensors such as a proximity sensor, ambient light sensor, temperature sensor or another sensor. The user interface may provide for setting a threshold level for the criteria that is listed for the task.

The method can continue to determine the presence of a user from sensor data (at 305), determine if executing a task would decrease performance of the computing system (at 310), and delay the task if sensor data indicates the computing system is in use and the execution of the task would decrease performance of the computing system (at 315).

The method can include notifying the user that the task is being delayed (at 420). The notification may be for example an audible or visual indictor such as a sound or a visual prompt on a display of the computing system. A visual indicator may be a message on the user interface on a display device.

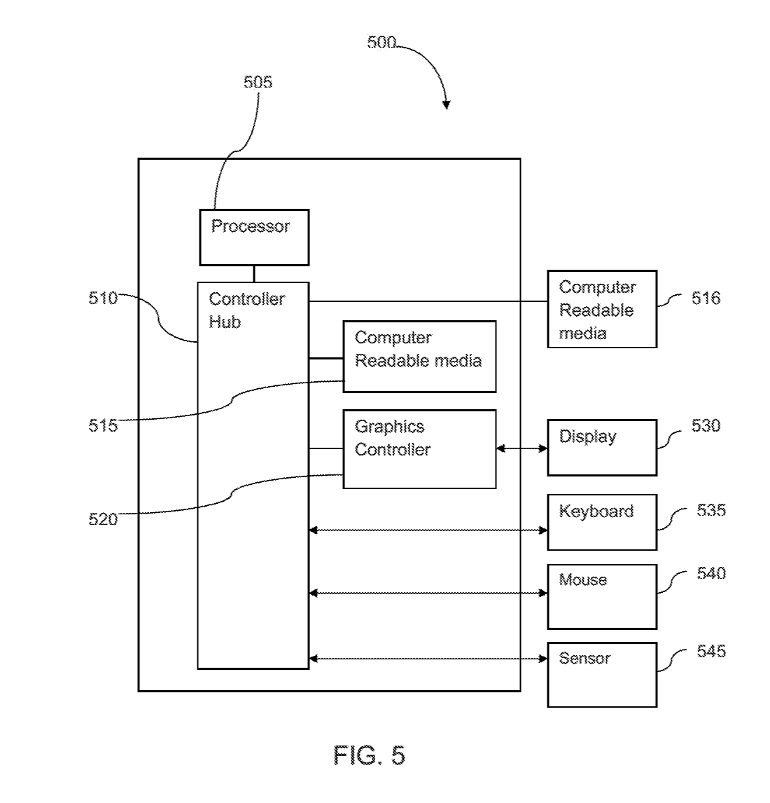

FIG. 5 is a block diagram of a computing system according to an example embodiment. The computing system can include a processor 505 to execute applications and tasks. The processor 505 can be connected to a controller hub 510. The controller hub 510 can connect to a graphics controller 520 to output a user interface to a display 530. The controller hub 510 can receive input from a keyboard 535, mouse 540, sensor 545 or another input device.

The computing system 500 may include a computer readable media 515 or 516. The computer readable media 515 or 516 may it code that if executed can cause a processor 505 to determine the presence of a user from sensor data, determine from a task scheduler if there is a task that execution is dependent on the presence of the user, and delay the task if sensor data indicates the task is dependent on the presence of the user and the user is present. The computer readable medium 515 or 516 may include code that if executed causes a processor 505 to delay at least one task of a virus scan, back up, automatic update if the task is dependent on the presence of the user and the user is present. The computer readable medium 515 or 516 may include code that if executed causes a processor 505 to notify the user that the task is delayed until the presence of the user is not detected.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CDROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing, description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fail within the true spirit and scope of the invention.

What is claimed is:

1. A computing system comprising:
a task scheduler;
a sensor to generate data on a external criteria; and
a controller to receive data from the sensor and delay or execute task in the task scheduler based on the data.

2. The system of claim 1, further comprising the controller to determine if a user is in proximity of the sensor.

3. The system of claim 2, further comprising the controller to delay the task if the user is in proximity of the sensor.

4. The system of claim 2, further comprising the controller to execute the task if the user is not in proximity of the sensor.

5. The system of claim 1, further comprising a notification to the user that a task has been delayed.

6. The system of claim 1, further comprising a second sensor to generate second data, wherein the controller is to receive the second data and delay or execute the task based on the data and the second data.

7. The system of claim 1, further comprising a user interface to select whether the execution of a task is effected by the data from the sensor or data from a second sensor.

8. A method of controlling tasks in a computing system comprising:
determining the presence of a user from sensor data;
determining if executing a task would decrease performance of the computing system;
delaying the task if sensor data indicates the computing system is in use and the execution of the task would decrease performance of the computing system.

9. The method of claim 8, wherein the task is a maintenance task.

10. The method of claim 8, further comprising notifying the user that the task is being delayed.

11. The method of claim 8, further comprising registering the task with a task scheduler.

12. The method of claim 11, further comprising configuring from a user interface if executing the task registered in the task scheduler is dependent on sensor data.

13. A computer readable medium comprising code that executed causes a processor to:
determine the presence of a user from sensor data;
determine from a task scheduler if there is a task that execution is dependent on the presence of the user;
delay the task if sensor data indicates the task is dependent on the presence of the user and the user is present.

14. The computer readable medium of claim 13 further comprising code that if executed causes a processor to:
delay at least one task of a virus scan, back up, automatic update if the task is dependent on the presence of the user and the user is present.

15. The computer readable medium of claim 14 further comprising code that if executed causes a processor to:
to notify the user that the task is delayed until the presence of the user is not detected.
